(19) United States
(12) Patent Application Publication
(10) Pub. No.: US 2025/0355663 A1
(43) Pub. Date: Nov. 20, 2025

(54) UPGRADE TOKEN PASSING FOR IN-PLACE COORDINATION OF CLUSTER UPGRADES

(71) Applicant: Nutanix, Inc., San Jose, CA (US)

(72) Inventors: Akash Ballal Chitpady, Bangalore (IN); Veeral Prabodhchandra Shah, Pune (IN); Shrikant Janardhan Jadhav, Pune (IN); Vanita Prabhu, Bengaluru (IN)

(73) Assignee: Nutanix, Inc., San Jose, CA (US)

(21) Appl. No.: 19/195,300

(22) Filed: Apr. 30, 2025

Related U.S. Application Data
(60) Provisional application No. 63/790,993, filed on Apr. 18, 2025.

(30) Foreign Application Priority Data
May 16, 2024 (IN) 202441038428
Jun. 25, 2024 (IN) 202441048657

(51) Int. Cl. G06F 8/656

(52) U.S. Cl. CPC G06F 8/656

(57) ABSTRACT

Methods, systems, and computer program products for managing code updates in computer clusters. Multiple components are operatively interconnected to carry out upgrade operations over nodes of a computer cluster. Specifically, in-place coordination of upgrades to a cluster (without requiring a temporary upgrade node) can be carried out by selecting a first node from the cluster, then enabling a protocol whereby operational elements of the cluster observe an upgrade token passing algorithm to ensure mutual exclusivity of a sequence of operations as between individual nodes of the cluster. Given such mutual exclusivity, the upgrading of the cluster can be carried out by applying code updates one node at a time. Migration of operational elements to and from nodes of the cluster (without requiring a temporary upgrade node) are facilitated by an intent processor. Computing clusters can be hyperconverged computer infrastructure clusters, and/or computing clusters can be Kubernetes or other computing clusters.

### RELATED APPLICATIONS

The present application claims the benefit of priority to U.S. Provisional Patent Application Ser. No. 63/790,993, titled “IN-PLACE COORDINATION OF CLUSTER UPGRADES WITHOUT REQUIRING A TEMPORARY UPGRADE NODE,” filed on Apr. 18, 2025, and the present application claims the benefit of priority to India patent application No. 202441048657 titled “IN-PLACE COORDINATION OF CLUSTER UPGRADESWITHOUT REQUIRING A TEMPORARY UPGRADE NODE,” filed on Jun. 25, 2024, which is hereby incorporated by reference in its entirety; and the present application claims benefit of priority to co-pending India patent application No. 202441038428, titled “CONTAINERIZED CLOUD-NATIVE CLUSTER OVERSEERS,” filed on May 16, 2024, all of which are hereby incorporated by reference in their entirety.

### TECHNICAL FIELD

This disclosure relates to hyperconverged computer clusters, and more particularly to techniques for in-place coordination of cluster upgrades without requiring a temporary upgrade node.

### BACKGROUND

In a multi-node cluster, performing a rolling upgrade often relies on the allocation of an additional node to facilitate the process. An additional node is used as a temporary location to migrate workloads or instances from the node undergoing the upgrade to the additional node while the node undergoes an upgrade. Reliance on an additional node ensures minimal downtime and avoids disruption. However, allocating an additional node has significant drawbacks (e.g., operational overhead, adds complexity, and limits the scalability of the rolling upgrade mechanism). Accordingly, there is a need for innovative technologies that advance the useful arts by addressing these deficiencies. The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for in-place coordination of cluster upgrades without requiring a temporary upgrade node, which techniques advance the relevant technologies to address technological issues with legacy approaches. More specifically, the present disclosure describes techniques used in systems, methods, and in computer program products for in-place coordination of a cluster-wide upgrade of a virtualization system's OS without requiring a temporary upgrade node. Certain embodiments are directed to technological solutions for planning and/or coordinating a node upgrade sequence using node upgrade/shutdown tokens. The term “upgrade token” and the term “shutdown token” are used interchangeably herein.

The disclosed embodiments modify and improve beyond legacy approaches. In particular, the herein-disclosed techniques provide technical solutions that address the technical problems attendant to how to carry out a zero-downtime cluster upgrade without requiring allocation of any additional nodes. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

For example, when performing computer operations that address the various technical problems underlying how to carry out a zero-downtime cluster upgrade without requiring allocation of an additional node, both memory usage and CPU cycles demanded are significantly reduced as compared to the memory usage and CPU cycles that would be needed but for practice of the herein-disclosed techniques for coordinating a node upgrade sequence using shutdown tokens. Strictly as one case, the data structures as disclosed herein and their use serve to reduce both memory usage and CPU cycles as compared to alternative approaches. Moreover, information that is received during operation of the embodiments is transformed by the processes that store data into and retrieve data from the aforementioned data structures.

The ordered combination of steps of the embodiments serve in the context of practical applications that perform steps for coordinating a node upgrade sequence using shutdown tokens more efficiently by using an upgrade token. As such, techniques for coordinating a node upgrade sequence using shutdown tokens overcome long-standing yet heretofore unsolved technological problems associated with how to carry out a zero-downtime cluster upgrade without requiring allocation of an additional node that arise in the realm of computer systems.

Many of the herein-disclosed embodiments for coordinating a node upgrade sequence using shutdown tokens are technological solutions pertaining to technological problems that arise in the hardware and software arts that underlie hyperconverged computer infrastructure (HCI) involving Kubernetes clusters. Aspects of the present disclosure achieve performance and other improvements in peripheral technical fields including, but not limited to, hyperconverged computing platform management and virtualization system management in a containerized environment.

Some embodiments include a sequence of instructions that are stored on a non-transitory computer readable medium. Such a sequence of instructions, when stored in memory and executed by one or more processors, causes the one or more processors to perform a set of acts for coordinating a node upgrade sequence using shutdown tokens.

Some embodiments include the aforementioned sequence of instructions that are stored in a memory, which memory is interfaced to one or more processors such that the one or more processors can execute the sequence of instructions to cause the one or more processors to implement acts for coordinating a node upgrade sequence using shutdown tokens.

In various embodiments, any combinations of any of the above can be organized to perform any variation of acts for in-place coordination of a cluster-wide upgrade of a virtualization system OS without requiring a temporary upgrade node, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1A presents a legacy approach to performing rolling upgrades.

FIG. 1B presents an approach to performing fully coordinated rolling upgrades without requiring a temporary upgrade node, according to some embodiments.

FIG. 1C exemplifies a cluster configuration technique using an intent processor for performing certain operations during performance of cluster-wide rolling upgrades, according to some embodiments.

FIG. 2A1 and FIG. 2A2 depict flowcharts showing a cluster-wide rolling upgrade technique as used when performing fully coordinated rolling upgrades of nodes of a cluster without requiring a temporary upgrade node, according to some embodiments.

FIG. 2B is a protocol diagram showing a cluster-wide rolling upgrade technique as used when performing fully coordinated rolling upgrades of nodes of a cluster without requiring a temporary upgrade node, according to some embodiments.

FIG. 3 exemplifies a series of pre-upgrade processing steps as used when preparing a node for a cluster-wide upgrade, according to some embodiments.

FIG. 4 is a flowchart that depicts series of upgrade processing steps as performed by each individual node of a cluster when carrying out in-place coordination of a cluster-wide upgrade, according to some embodiments.

FIG. 5A, FIG. 5B, FIG. 5C, and FIG. 5D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for implementing an upgrade token-passing regime to facilitate in-place cluster upgrades. Problems pertaining to carrying out a zero-downtime cluster upgrade (e.g., in the context of computer clusters involving Kubernetes clusters) without requiring an additional node are unique to, and may have been created by, various legacy computer-implemented methods. Some embodiments are directed to approaches for coordinating a node upgrade sequence using shutdown tokens. The accompanying figures and discussions herein present example environments, systems, methods, and computer program products for fully coordinated rolling upgrades without requiring a temporary upgrade node.

### Overview

In the context of computer clusters involving Kubernetes clusters, rolling code updates involve incrementally replacing Kubernetes pods with upgraded Kubernetes pods. More specifically, the upgraded Kubernetes pods are scheduled on existing nodes that have sufficient available resources. Kubernetes waits for those new pods to start before removing the old pods. The disclosure herein improves over legacy rolling update models. Such legacy rolling update models include (1) the update model colloquially known as “Blue-Green,” and (2) the update model known an “Canary.” The Blue-Green upgrade model involves a load balancer that operates over two identical runtime environments. The update procedure involves downloading a new, updated version of the application into the Green environment. While the application is being upgraded the application is served from the Blue environment. Once the new upgraded version in the Green environment is stable, then the load balancer is reconfigured so as to switch the traffic from the Blue environment to the Green environment. One glaring deficiency with the foregoing Blue-Green model is the demand for deployment of concurrently operational infrastructure capacity so as to implement both the Blue environment as well as the Green environment. This often incurs a monetary cost as well as operational burdens, both of which are strongly unwanted.

An alternative legacy rolling upgrade model is known as the “Canary” model. In the Canary model, one or more additional nodes, known as “canary nodes,” are added to the then currently-operational nodes of the infrastructure. A load balancer gradually directs the traffic to the added canary nodes while individual ones of the then currently-operational nodes of the infrastructure are upgraded, thus gradually bringing up the newly added nodes until they are performing satisfactorily with the upgraded configuration. This gradual approach continues until all needed nodes have been upgraded, at which point the load balancer switches over to use just the newly-upgraded nodes. The drawback of this approach is that it still requires at least one of the aforementioned additional canary nodes. Further, this technique requires a load balancer as well as monitoring facilities that are configured to be able to closely monitor operations while the system is being upgraded.

The problem to be solved is therefore rooted in various technological limitations of legacy approaches. Improved technologies are needed. In particular, the need for an additional allocated node during rolling upgrades needs to be eliminated. This can be accomplished by implementing a mechanism that enables the use of already available nodes within the cluster. In container management systems (e.g., Kubernetes), achieving the capability to implement rolling upgrades with minimal or no downtime is a widely desired objective.

As used herein, the term “container management systems” and/or the term “containerized system” or the term “executable container system”, refers to a computing environment wherein executable units are deployed as self-contained executable units. In some embodiments, such a container management system or containerized system includes or is subsumed into a Kubernetes environment.

The disclosed embodiments herein use an upgrade token to facilitate rolling cluster updates-yet without requiring additional resources (e.g., additional nodes). An overseer computing process (possibly but not necessarily supplanted by actions of a human operator) coordinates the upgrade of individual nodes using the approaches as outlined in the steps below. Adherence to a strict upgrade token passing algorithm and protocol ensures that (1) there is only one live upgrade token in any rolling upgrade scenario, and (2) each node keeps track of its handling of the single live upgrade token for the duration of its portion of processing within the rolling upgrade scenario.

### Example Step-by-Step Approach

Table 1 shows a step-by-step approach to fully coordinated rolling upgrades without requiring a temporary upgrade node.

TABLE 1

| Step | Description |
|---|---|
| 1 | A user interface (e.g., command line interface, application programming interface) triggers an upgrade |
| | operation (e.g., systematic set of actions or procedures carried out to update the nodes). |
| 2 | Interaction over the user interface and/or invocation of an application programming interface |
| | establishes a rolling node upgrade intent in a cluster state database or alternatively, in a persistent |
| | volume such as etcd. Such a persistent volume can be attached/detached at will under programmatic |
| | control. |
| 3 | An operational element (e.g., a container-attached storage module) picks up (e.g., via a routine or an |
| | operator) the intent and infers the scope of the upgrade (e.g., to upgrade the operating system and or |
| | other mission critical modules). |
| 4 | One or more operational elements perform pre-checks (e.g., verifying sufficient memory availability for |
| | the update), after which an action to actually initiate the upgrade of a node (e.g., a pod, a container, a |
| | process, a computer, a processing element, a rack, etc.) is made. |
| 5 | Individual ones of the nodes of the cluster each request and, in a mutually-exclusive manner, receive |
| | the upgrade token from the token manager. This can be accomplished via uniquely reserving a token |
| | (e.g., under semaphore control) from a token repository. Such a token repository may host many types |
| | of tokens beyond the herein-discussed upgrade token. |
| 6 | In the case of upgrading a virtualization system's OS and/or in the case of upgrading a containerized |
| | system's host OS or a containerized system's pod software, a strictly-controlled sequence of node |
| | operations is carried out where, for example, each virtualization system's OS pod autonomously |
| | retrieves and downloads applicable upgrade binaries. In some cases, the applicable upgrade binaries |
| | are composed of a first binary that performs the aforementioned pre-checks, and a second binary that |
| | is the installer for the upgrade. |
| 7 | After retrieving the applicable upgrade binaries, the upgrades are executed to completion (e.g., in |
| | accordance with an upgrade script, or in accordance with achievement of an intended state). |
| 8 | Once the cluster-wide upgrade is complete, the last-upgraded node returns the upgrade token to the |
| | token repository, thus releasing the upgrade token for use in some further endeavor. |

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

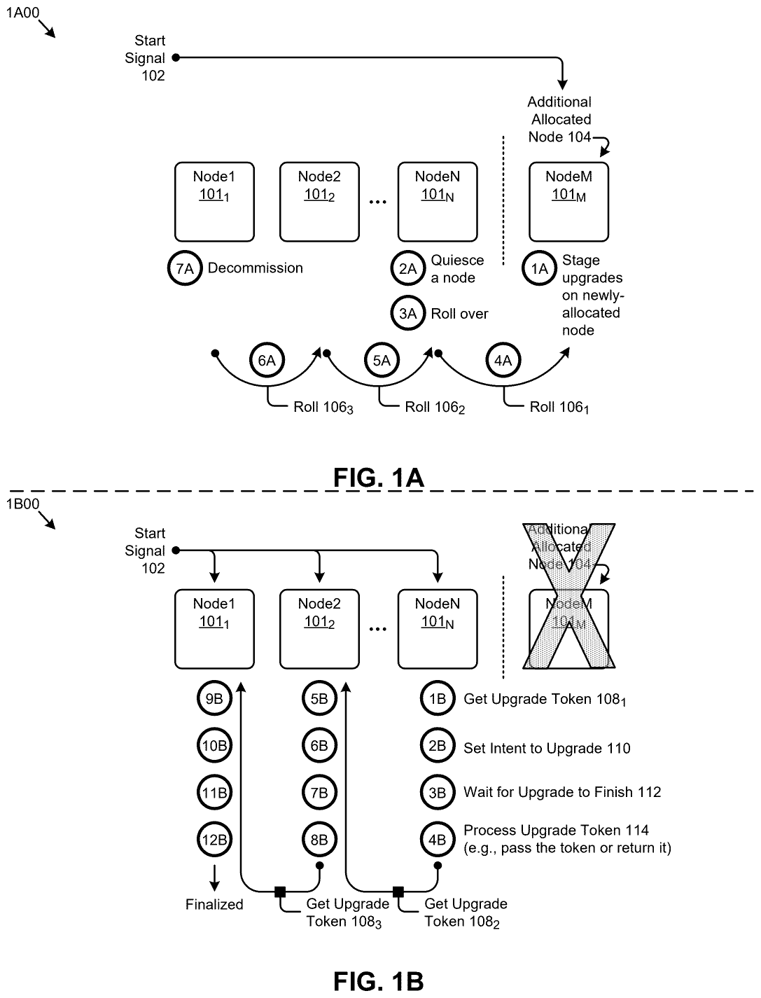

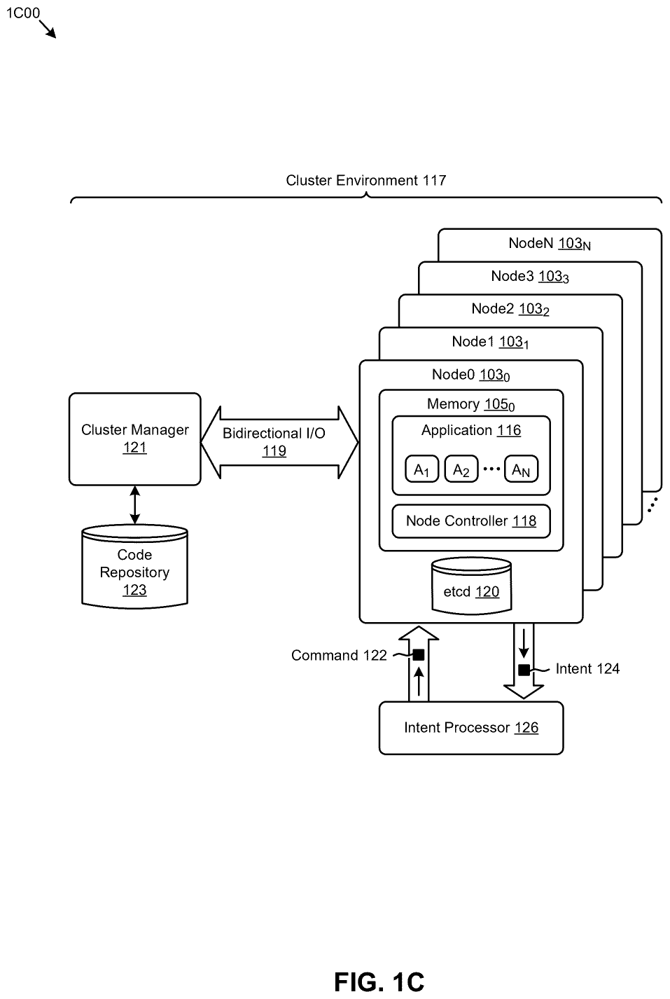

FIG. 1A depicts a legacy approach to performing rolling code updates. As an option, one or more variations of legacy approach 1A00 or any aspect thereof may be implemented in the context of the architecture and functionality of the embodiments described herein and/or in any environment.

FIG. 1A is being presented to highlight how rolling upgrade legacy approaches rely on additional resources (e.g., an additional allocated node 104) in a multi-node cluster environment. The shown system includes a start signal 102, an additional allocated node 104 (e.g., NodeM 101_{M}), and several to-be-upgraded nodes (e.g., Node1 101₁, Node2 101₂, . . . , NodeN 101_{N}). Start signal 102 (e.g., a command-line interface) initiates the rolling upgrade process. Once the upgrade process has been initiated, various checks are performed to verify all necessary conditions (e.g., system compatibility, resource availability) are met so as to support the upgrade. Upon completed validation checks, the system creates the additional allocated node 104 (e.g., shown in this example as NodeM 101_{M}) for temporary use during the cluster-wide upgrade process. After creation of such an additional allocated node, the system will stage upgrades using the newly-allocated node (operation 1A).

Using this legacy technique involving a temporarily-allocated node, it is only after the system has prepared the additional allocated node that the upgrade can be commenced. As an overview of this legacy technique, the system delegates a node (e.g., shown in this example as NodeN 101_{N}) to be upgraded first. The upgrade process proceeds to quiesce the node (operation 2A) after which a roll over operation (operation 3A) occurs.

In further detail, once the additional node and/or its environment is validated as functioning correctly, the system proceeds to roll out the update to the first to-be-updated node (e.g., shown in this instance as NodeN 101_{N}) in the cluster. As shown, the rollout to the remaining nodes occurs sequentially through step 4A (e.g., roll 106₁), step 5A (e.g., roll 106₂), and step 6A (e.g., roll 1063). In this example the process concludes with step 7A, where the now outdated (and replaced) node is decommissioned (e.g., by removing the temporary node from the cluster and releasing any temporarily-allocated resources). Unfortunately, this legacy approach exhibits the technological deficiency of requiring a temporary node, which is one particular area that requires improvement so as to eliminate the need for such temporarily-allocated resources. The following FIG. 1B shows and describes techniques that improve over the foregoing legacy approach.

FIG. 1B presents an approach to performing fully coordinated rolling upgrades without requiring a temporary upgrade node. Specifically, using an upgrade token and a token passing protocol, various limitations of traditional methods are addressed. Still more specifically, FIG. 1B offers an improved solution for performing rolling code updates without changing the footprint of the cluster being upgraded. As an option, one or more variations of the herein-disclosed approach 1B00 or any aspect thereof may be implemented in the context of the architecture and functionality of the embodiments described herein and/or in any environment.

FIG. 1B is being presented to highlight an embodiment that eliminates the need for an additional allocated node during a rolling upgrade process. The embodiment highlights the flow of operations performed when upgrading nodes within containerized environments (e.g., Kubernetes). The shown system includes a start signal 102 that is triggered by an event (e.g., command line input, application programming interface, etc.). FIG. 1B also shows several computing nodes (e.g., Node1 101₁ . . . , Node2 101₂, . . . , NodeN 101_{N}) any/all of which are configured to receive the start signal. As shown by the stippled ‘X’, the start signal initiates the upgrade process-yet without the need for an additional temporary node. Rather, instead of using an additional temporary node, the upgrade leverages the nodes already available within the cluster itself. This is an advance over the techniques used in legacy methods.

In one embodiment, an agent coordinates the process to ensure that upgrades are performed sequentially in a strict sequence with only one node undergoing the upgrade at a time. In the shown embodiment, after the start signal initiates the upgrade process, one of the nodes of the cluster (in this example, the node shown as NodeN 101_{N}) responds to receiving the signal to begin the upgrade by getting an upgrade token 1081 (step 1B).

As shown, NodeN 101_{N} will follow with step 2B to signal its intent to upgrade 110, which step may involve an intent processor 126 (shown in FIG. 1C). The embodiment of step 2B sets its intent to upgrade following any one or more steps for obtaining the upgrade token. In various embodiments, steps to get an upgrade token (e.g., 108₁) may encompasses retrieving an upgrade token from a token repository. Alternatively, steps to get an upgrade token (e.g., 108₁) may encompasses retrieving an upgrade token from an agent.

Upon receipt of the upgrade token, the subject node waits for upgrade processes to initiate the upgrade, and then to finish 112 (step 3B). Finally, step 4B involves returning the upgrade token, or (as shown) passing the upgrade token (e.g., operation 114) to a next node (e.g., Node2 101₂). In this implementation, the upgraded node releases the upgrade token back to the repository, thus making the upgrades token available for the next node. The next node may have passed all the prechecks, and thusly is ready for a rolling upgrade. In another implementation, a next node in line, possibly due to a particular topology, or possibly as designated by the agent, receives or retrieves upgrade token 1082 and proceeds with the next node's contribution to the upgrade process.

As depicted, this process continues sequentially to Node2 101₂, which process follows the corresponding steps (e.g., step 5B, step 6B, step 7B, and step 8B) mirroring the foregoing step 1B, step 2B, step 3B, and step 4B. The process continues with an upgrade to a further node, in this case, Node1 101₁, which gets upgrade token 1083 and proceeds through corresponding steps (e.g., step 9B, step 10B, step 11B, and step 12B). which mirror the foregoing steps (e.g., step 5B, step 6B, step 7B, and step 8B). Upon completion of these steps, the cluster-wide upgrade process is finalized.

While the steps as discussed hereinabove are presented in a sequential fashion, this is merely one embodiment, and depending on the specific environment or topology or implementation, the steps may be performed in a different order or may be performed wholly or partially concurrently.

Intent-driven processing techniques, specifically techniques for setting the upgrade intent on a node as the initial step in the upgrade process, are presented infra. The intent-driven processing techniques involve the use of an intent processor to perform certain operations that advance toward a particular desired state of the cluster.

Further details pertaining to handling intents are disclosed in U.S. Pat. No. 11,900,172, issued on Feb. 13, 2024, which is hereby incorporated herein by reference.

FIG. 1C exemplifies a cluster configuration technique 1C00 using an intent processor for performing certain operations during performance of cluster-wide rolling upgrades. As an option, one or more variations of cluster configuration technique 1C00 or any aspect thereof may be implemented in the context of the architecture and functionality of the embodiments described herein and/or in any environment.

Specifically, FIG. 1C illustrates the functionality of an intent processor 126 within a cluster environment 117 (e.g., a Kubernetes cluster environment). The intent processor is responsible for coordinating the execution of operations that advance toward one or more intended states (e.g., intents) within such a cluster environment. This figure demonstrates the interactions between various components to facilitate the upgrade.

Specifically, in this embodiment, a cluster manager 121 interacts with the code repository 123 via bidirectional I/O (input/output or IO) (e.g., bidirectional I/O 119) to retrieve (directly or indirectly) configuration files or desired state specifications. These retrieved intents (e.g., intent 124) are processed by the intent processor, which translates the high-level intents into commands (e.g., command 122).

In operation, the intent processor sends or otherwise causes specific commands to be entered into node-specific memories (e.g., memory 1050) of particular nodes (e.g., node0 103₀, node1 103₁, node2 103₂, node3 103₃, node4 103_{N}), where a particular node includes an application 116, a node controller 118, and its etcd database. The intent processor coordinates with any/all of the nodes to ensure the desired state is achieved. The intent processor is configured to receive feedback or status updates from any node to confirm successful execution on that node. Moreover, intent processor 126 serves as a repository for any status(es) pertaining to any node, and is able to report (e.g., synchronously or asynchronously) to confirm successful execution.

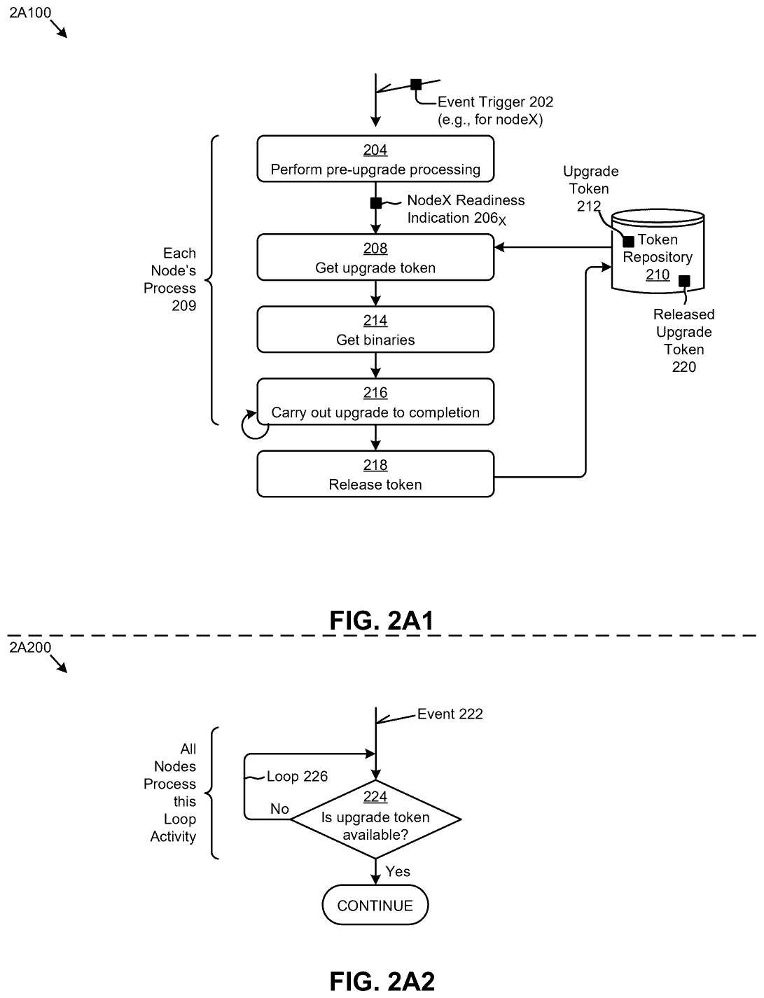

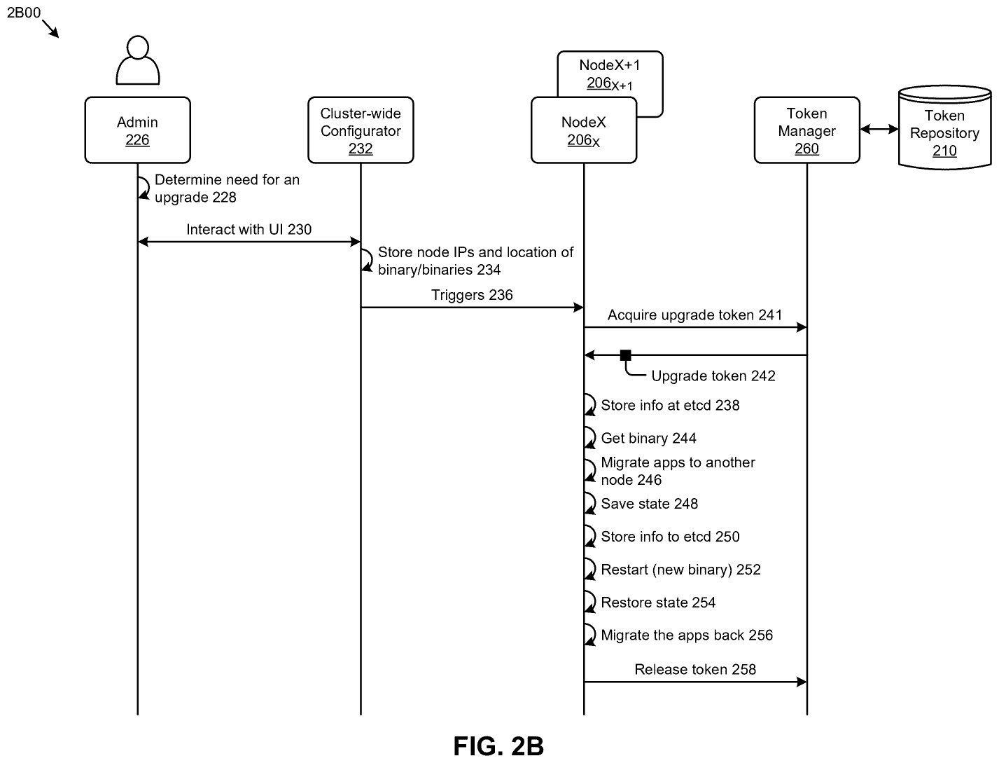

FIG. 2A1 and FIG. 2A2 depict flowcharts showing a first example cluster-wide rolling upgrade technique 2A100 and a second example cluster-wide rolling upgrade technique 2A200 as used when performing fully coordinated rolling upgrades of nodes of a cluster without requiring a temporary upgrade node. As an option, one or more variations of the first example cluster-wide rolling upgrade technique 2A100 and/or one or more variations of the second example cluster-wide rolling upgrade technique 2A200 or any aspect thereof may be implemented in the context of the architecture and functionality of the embodiments described herein and/or in any environment.

FIG. 2A1 illustrates an operation flow for performing rolling code updates in a cluster environment (e.g., under Kubernetes) without using a temporary upgrade node. The figure is being presented to provide a detailed overview of how the rolling update process can be executed while optimizing existing resources within the cluster. In cases where a rolling upgrade process is initiated/coordinated by an operator, the operator selects a first node to receive the upgrade token at a given initial moment in time. As an example, the operator may interact with the token repository (e.g., through a user interface) to assign the upgrade token to some particular node that has passed all the pre-upgrade checks (e.g., memory availability, CPU load, etc.). As used herein, an operator can be a human person, or an operator can be a collection of executable upgrade code. In some cases, such a collection of executable upgrade code may be in the form of a storage corpus that is accessible to an operator of custom resource definition (CRD), which operators of custom resource definitions are known to those of skill in the art. It can happen that an operator (e.g., an operator of custom resource definition) might itself be upgraded or otherwise modified from time to time, such as during the time period between upgrades.

### Handling Custom Resource Definitions Modifications Across Upgrades

When upgrading an operator, the new version of the CRD can introduce additional fields or modify existing ones while maintaining backward compatibility with the previous version. During the upgrade process, the operator should be able to handle both old and new versions of the CRD, ensuring that existing resources remain functional and that new resources can leverage any new features or changes. Conversion webhooks play a role in this process by enabling automatic conversion between different versions of the CRD. They allow for on-the-fly transformation of CRD objects between different versions, ensuring seamless compatibility during upgrades without requiring manual intervention.

The shown operation flow is initiated by an event trigger 202 which may be caused by an application programming interface (API) call, and/or a command-line input (CLI) call that initiates the rolling upgrade process. Some systems include an autonomous node manager and/or a system lifecycle manager, etc. The event trigger signals the receiving system to begin pre-upgrade processing 204 (e.g., validate the readiness of the environment). In one embodiment, pre-upgrade processing involves resource checks (e.g., verifying available memory, CPU, disk space) on the node to ensure it can handle the upgrade. In a related embodiment, certain upgrade operations include additional checks that may include verifying network connectivity and ensuring the node is in a healthy state. In some cases, the series of pre-checks may include determining if another cluster is currently undergoing an upgrade, and if so, then delaying further upgrade operations and/or advising an administrator. Once the pre-upgrade processing is complete, the designated upgrade on a particular node proceeds.

The flow then proceeds to obtain the upgrade token (at step 208) from the token repository 210 through any known mechanism (e.g., semaphore-controlled access, polling, etc.). The shown token repository is merely one way to manage handling of an upgrade token. Upon a request from a node to be upgraded, the token repository itself, or an agent, makes a currently available instance of an upgrade token 212 available to the requesting node. However, there are situations where the upgrade token is unavailable at the moment when the node requests it. In such a situation, a single threading mechanism (e.g., a test-and-set atomic operation, a semaphore, etc.) will communicate to the requesting node that the upgrade token is already in use. The single threading mechanism ensures that only one node holds the upgrade token at a time, maintaining the sequential nature of the rolling upgrade process. Once the upgrade token becomes available, a next node will request and receive the upgrade token.

The cluster-wide rolling update technique proceeds by having a particular designated node instance get is corresponding binaries (step 214). In a related embodiment, the binaries may include updated container images or configuration files from a container registry (e.g., a Docker Hub). Once the binaries have been obtained (e.g., validated), the node carries out the upgrade to completion (step 216). In one example, the completion may include executing a finish script to finalize the upgrade. In some situations and/or environments, there may be a pre-existing upgrade facility. In some such cases, the upgrade may be signaled by an API call or a CLI command.

As denoted in FIG. 2A1, each node's process 209 will contain the aforementioned steps (e.g., pre-upgrade processing 204, step 208, step 214, step 216, and step 218). Moreover, FIG. 2A1 shows individual, node-specific data items (e.g., upgrade token 212, node readiness indication 206_{X}, etc.). Strictly as one example of a node-specific operation, and as shown, a node-specific upgrade token can be released (e.g., back into the token repository) if/when all conditions for a successful upgrade are met (e.g., installing or applying all upgrade binaries). At step 218, the upgrade token is released, thus changing its status to be a released upgrade token 220. As shown, such a released upgrade token can be stored in the token repository so as to become available for further use (e.g., by a next node to be upgraded). In this and other contexts, a upgrade token, or more specifically the status of an upgrade token can be maintained in a collection of things, additionally or alternatively the status of an upgrade token can be maintained in one or more data structures.

FIG. 2A2 illustrates ongoing and concurrent polling activity that occurs across all nodes in the cluster during the rolling upgrade process. Upon occurrence of event 222 (e.g., an API request event or a command line interface event), a particular node check for availability of the upgrade token (check 224) is performed. If the upgrade token is available (see “Yes” branch), the designated node proceeds to check out the upgrade token and then continues with the upgrade process. If the upgrade token is not available (see “No” branch), the node enters loop 226 which includes a wait period and/or an event notification to any event listeners. After a time period (e.g., a wait period or a time period during which action is taken by an event listener), processing loops back to check 224 to recheck for token availability.

This approach ensures that only one node at a time undergoes an upgrade. In the case of an unexpected disruption (e.g., a failure situation or unexpected shutdown) during the rolling update, the system ensures that the node holding the upgrade token resumes the upgrade process upon reactivation.

In comparison to legacy approaches (e.g., Blue-Green deployment, Canary deployment) performing rolling code updates in a cluster environment (e.g., Kubernetes) without a temporary upgrade node eliminates the need for additional temporary nodes. Instead, the herein-disclosed token-based approach leverages existing resources. One embodiment of a protocol implementing the process illustrated in FIG. 2A1 is depicted in FIG. 2B.

FIG. 2B is a protocol diagram showing a cluster-wide rolling upgrade technique 2B00 as used when performing fully coordinated rolling upgrades of nodes of a cluster without requiring a temporary upgrade node. As an option, one or more variations of cluster-wide rolling upgrade technique 2B00 or any aspect thereof may be implemented in the context of the architecture and functionality of the embodiments described herein and/or in any environment.

FIG. 2B is being presented to provide a protocol for performing cluster-wide rolling code updates, which protocol is used when performing fully coordinated rolling upgrades of nodes of a cluster without requiring a temporary upgrade node. The protocol begins with an administrator or another type of entity (e.g., a computer-implemented agent) that, using any known technique, determines the need for an upgrade. In this particular embodiment, such an administrator or another entity determines the need for a cluster upgrade (operation 228) which cluster upgrade may include one or more updates to any one or more of (1) a virtualization system's operating system (VOS), (2) one or more containerized runtime modules, and/or (3) one or more containerized application software modules. In various embodiments, the determination for the need of a cluster upgrade could be based on a scheduled maintenance window, or based on a system alert indicating outdated software, or based on the deployment of new features requiring an update, etc. In the case of a human administrator, such an administrator interacts with user interface 230 (e.g., command-line tool, web-based dashboard, API), and through that interaction, initiates the cluster upgrade via communication with cluster-wide configurator 232. Such interaction between the administrator and the shown user interface helps the administrator to define parameters pertaining to the upgrade (e.g., which nodes to be updated, which source version of the VOS, which replacement version of the VOS, etc.). At step 234 of the protocol, the cluster wide configuration system stores essential information (e.g., the node IP addresses, location of binary/binaries, etc.). As an alternative, a computer-implemented agent interacts with the cluster-wide configurator to define and store upgrade parameters pertaining to the upgrade. The protocol then continues with further steps in the upgrade process, which in turn results in triggering a node, or possibly all nodes (e.g., NodeX, Node X+1, etc.) with one or more triggers 236.

At step 240, the node requests the upgrade token from the token manager 260, which acts as an intermediary between the node and token repository 210. More particularly, the token manager is configured to ensure that only one node at a time acquires the upgrade token. Upon a particular node's successful acquisition of an upgrade token 242 (e.g. via interaction 241), the protocol stores information (e.g., upgrade intent information) in a storage location (e.g., in a distributed key-value store such) and/or as a bit field in the etcd (operation 238).

Once the token manager processes the request, it communicates with the token repository to release the upgrade token. After receiving the upgrade token, the node proceeds to retrieve the binaries 244 (e.g., VOS update files, configuration updates). At step 246, the node temporarily migrates its applications to another node of the cluster. Temporarily migrating the applications may involve transferring active workloads and the associated state to an existing node within the cluster, thus utilizing a node that is already available rather than creating an additional temporary node. Using the already available node of the cluster optimizes resource usage by leveraging the cluster's existing infrastructure (i.e. rather than creating or allocating an additional temporary node).

At step 248, the protocol saves the current state (e.g., runtime configuration, session data) of the node before proceeding with the update. Storing the current state helps ensure that the system can be restored to the previous state. The information might also be stored in etcd (operation 250). The node then restarts with the new binary/binaries 252, which binaries are configured to solely, or in conjunction with other computer processes, to apply the update. In some cases, applying the update may involve loading the updated virtualization operating system binaries and reinitializing the system.

At operation 254, the node restores the pre-update state, including configurations and any saved session data. Once the node confirms readiness, the node returns (e.g., re-migrates) the formerly migrated applications back to the updated node (operation 256). The protocol releases the upgrade token (message 258) back to the token repository, thus allowing a next node (e.g., Node_{X+1}), if any, to commence its upgrade.

As can be seen, the foregoing implements a token passing algorithm so as to ensure mutual exclusivity of a sequence of operations as between individual nodes of the cluster. That is, only one node of the cluster at a time will be undergoing active upgrade modifications.

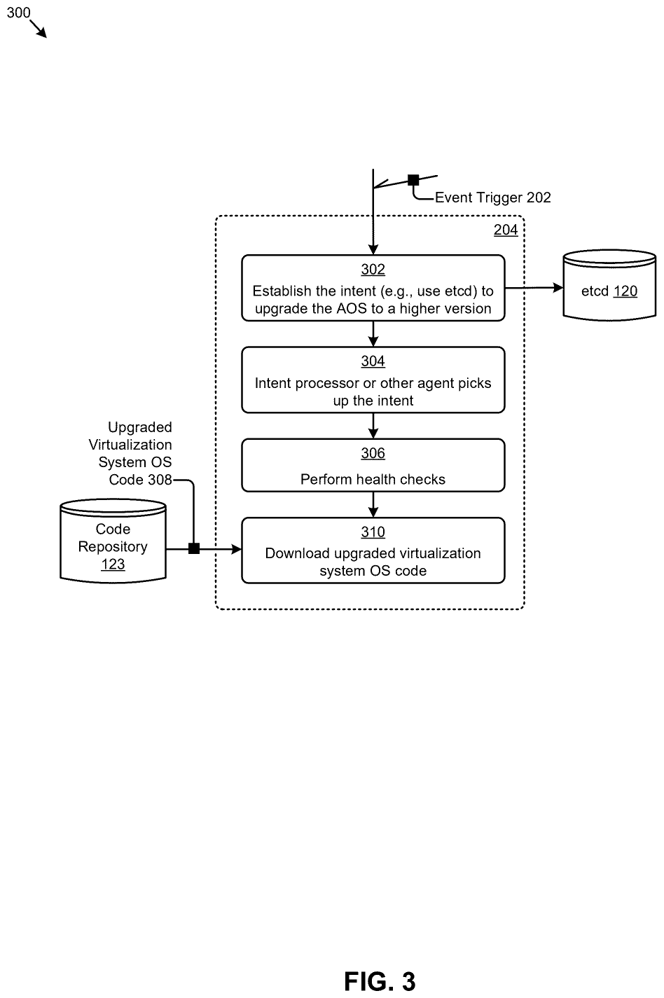

Referring again to FIG. 2A1, pre-upgrade processing 204 can include any processing using any known methods. More particularly FIG. 3 and the corresponding description exemplifies the specific pre-upgrade processing steps used when preparing a node for a virtualization system OS upgrade. In particular, FIG. 3 highlights the necessary checks and validations required to ensure the node's readiness for the upgrade.

FIG. 3 exemplifies a series of pre-upgrade processing steps 300 as used when preparing a node for a cluster-wide upgrade. As an option, one or more variations of pre-upgrade processing steps 300 or any aspect thereof may be implemented in the context of the architecture and functionality of the embodiments described herein and/or in any environment.

FIG. 3 depicts a flowchart detailing steps involved in carrying out pre-upgrade processing 204 as depicted in FIG. 2A1. As shown in FIG. 3, the process begins with an event trigger 202 (e.g., API request event, command-line instruction event), which initiates the pre-upgrade processing for the designated node. In this embodiment, presented strictly as an illustrative example of pre-upgrade processing, the first step is to establish the intent to upgrade the OS to a higher version (step 302). This involves communicating with a node-specific state storage (e.g., etcd 120) to record the intent. Strictly as one example, the system may indicate the desired upgrade version and status of the node within a node-specific state storage (e.g., etcd 120). The next step (step 304) involves raising an event to be recognized by the intent process (or other agent picking up the intent), upon which event the intent process retrieves the upgrade details needed to proceed with the upgrade. Once the intent is picked up, the system performs a series of health checks (step 306) to validate the node's readiness for the upgrade. These health checks may include confirming sufficient memory, CPU, disk space, etc.

If all health checks pass, the node proceeds to step 310, which serves to download the upgraded virtualization system's OS code 308. Downloading the upgraded virtualization system's OS code involves retrieving the upgraded virtualization system's OS code 308 from a designated repository (e.g., code repository 123). The system ensures that the specified verified version of OS code is used, and that the integrity of the downloaded binaries is confirmed.

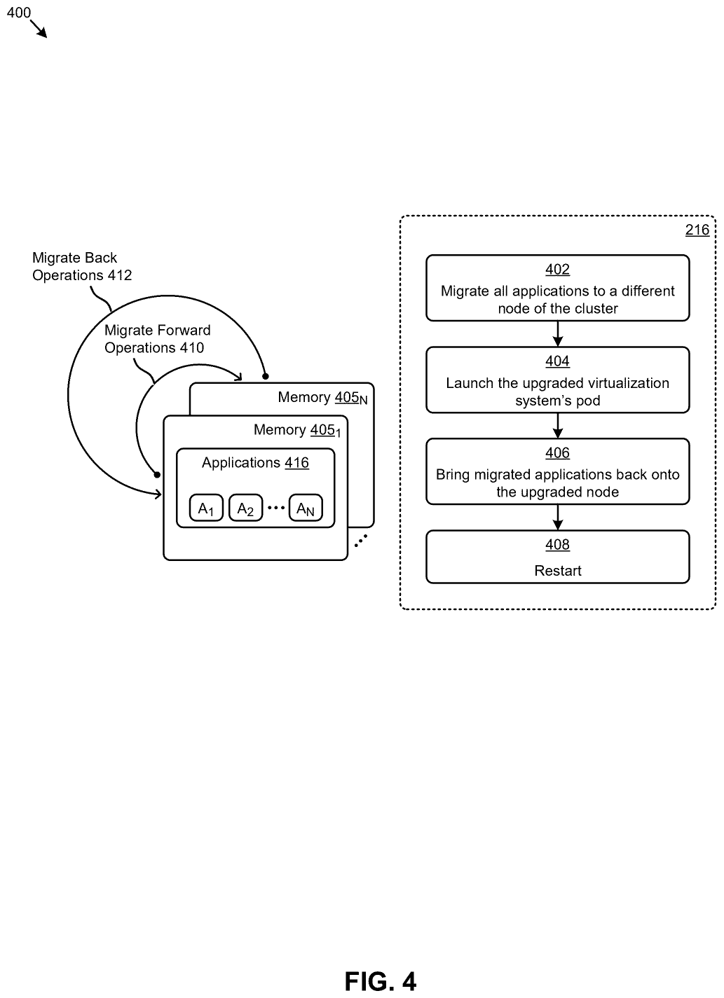

FIG. 3 is presented to provide a detailed breakdown of the pre-upgrade processing steps that prepare a node for the virtualization system OS upgrade. The figure highlights the critical tasks and interactions required to ensure that the node is ready for the update, emphasizing the importance of readiness in the rolling update process. Further steps to carry out the upgrade to completion is shown and discussed as pertains to FIG. 4.

FIG. 4 is a flowchart that depicts a series of upgrade processing steps as performed by each individual node of a cluster when carrying out in-place coordination of a cluster-wide upgrade without requiring a temporary upgrade node. As an option, one or more variations of upgrade processing steps 400 or any aspect thereof may be implemented in the context of the architecture and functionality of the embodiments described herein and/or in any environment.

FIG. 4 is a flowchart that details certain of the process of carrying out the upgrade to completion in a rolling update without requiring a temporary upgrade node. In particular, FIG. 4 depicts a flowchart detailing steps involved in carrying out pre-upgrade processing 204. This figure outlines the specific steps performed on each node during the upgrade. All or portions of the steps of FIG. 4 comprise a method for coordinating a cluster-wide upgrade of a virtualization system OS using existing infrastructure.

As depicted in step 402, the first step is to migrate all applications of a current node to a different node within cluster. For example, and as presented in FIG. 4, in a Kubernetes environment the migration might involve migrating applications forward from (for example) Node_{X} onto (for example) Node_{X+1}. Migrated applications are then verified to have been successfully migrated. Such verifications may include validating that the applications are fully operational on the target node and that no applications remain on the source node.

Step 404 involves launching the upgraded virtualization system's OS pod a subject node. This may include, for example, installing the downloaded binaries, restarting system services, and initializing configurations specific to the pod that subsumes the new OS version. Through effect of step 404, the upgraded OS is brought into operation and prepared for ongoing usage.

At step 406, the process involves bringing the previously migrated applications back onto the upgraded node. This is shown on the left side of FIG. 4, where the applications 416 (e.g., application A₁, application A₂, . . . , application AN) are first subjected to migrate forward operations 410 (e.g., during processing of step 402) and then later subjected to migrate back operations 412 (e.g., during processing of step 406). As shown, the applications, in whole or in part, are stored in a memory of a node. In the specific example of FIG. 4, a first set of applications (e.g., to be migrated applications) are stored in memory 4051 (corresponding to a first node of the cluster). The migration process results in a second set of applications being stored in memory 405N (corresponding to an Nth node of the cluster).

Step 408 implements a restart of the node (or any or all of the node's constituent processes) so as to finalize the upgrade process. This step completes the configuration and initialization of services associated with the upgrade. A restart of the node may involve rebooting the node or restarting specific services as may be required by the upgrade.

This figure is presented to provide a detailed and actionable description of the rolling upgrade process, illustrating how the migration, upgrade, and reintegration steps are performed using existing cluster resources. By eliminating the need for temporary upgrade nodes, the method demonstrates a resource-efficient approach to virtualization system OS upgrades.

### System Architecture Overview

### Additional System Architecture Examples

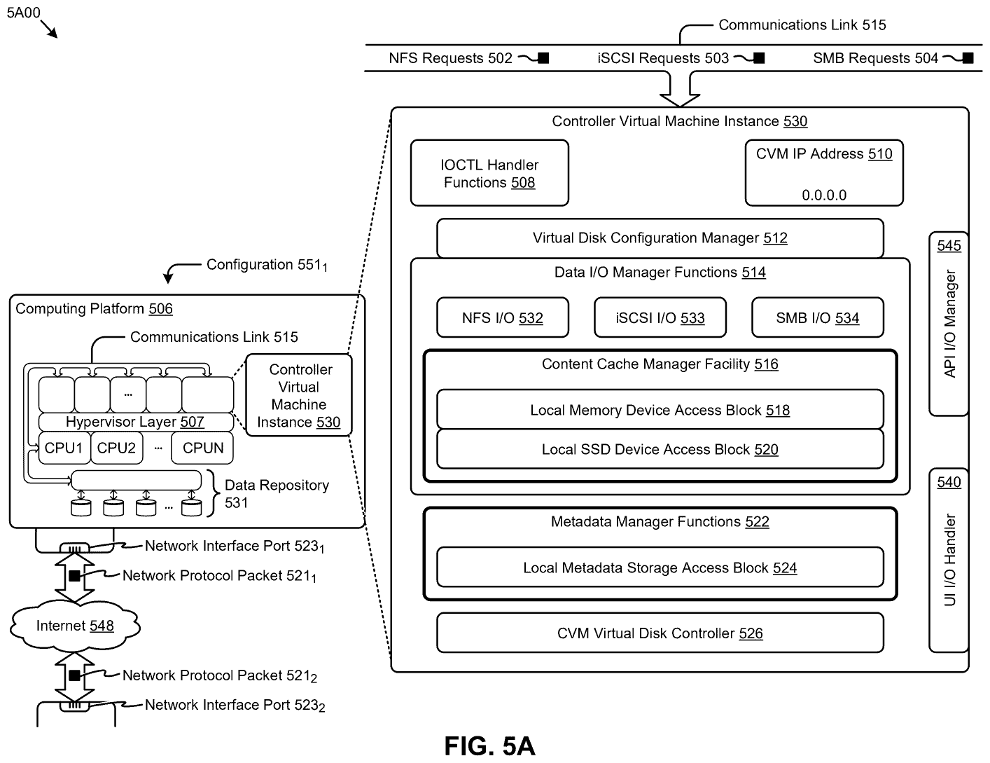

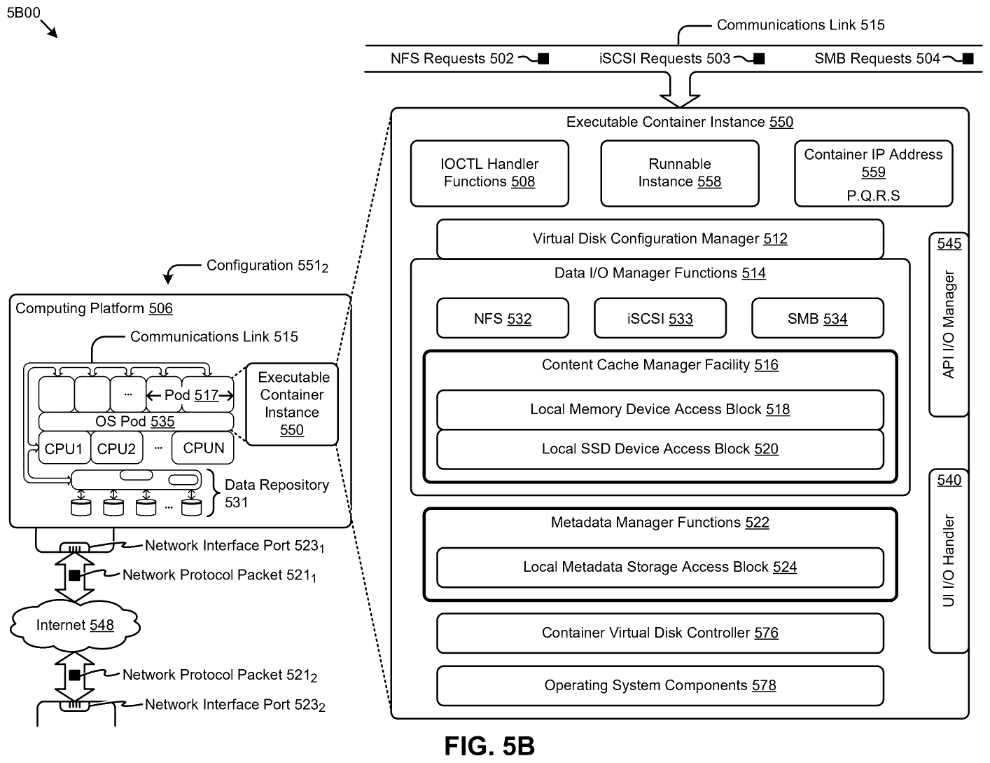

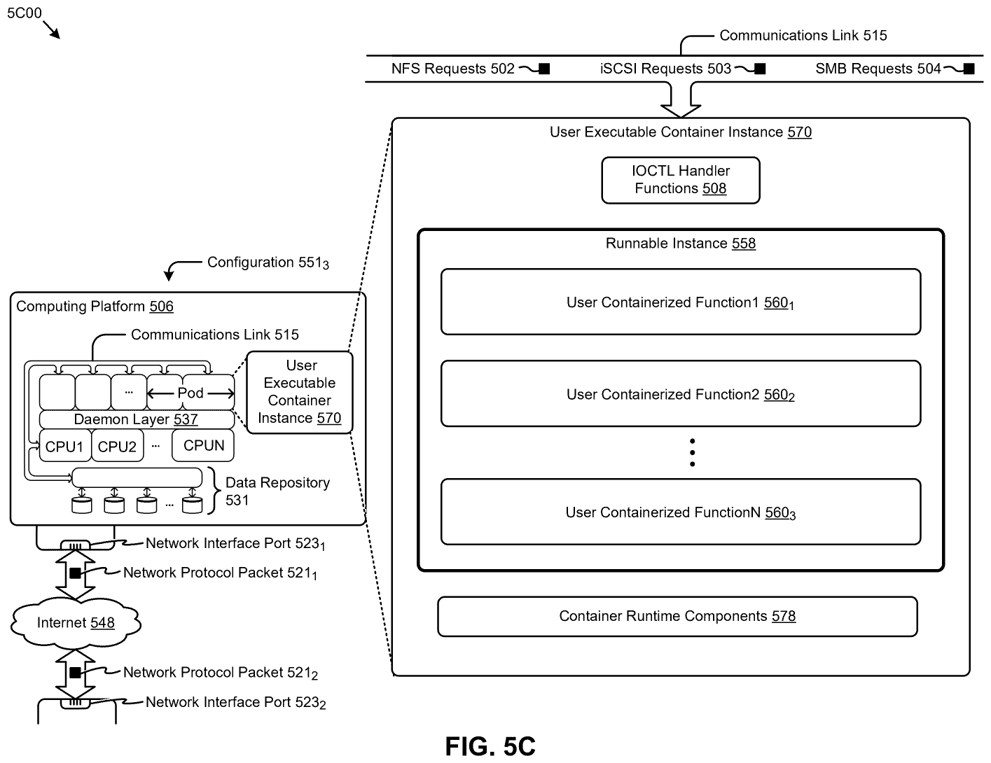

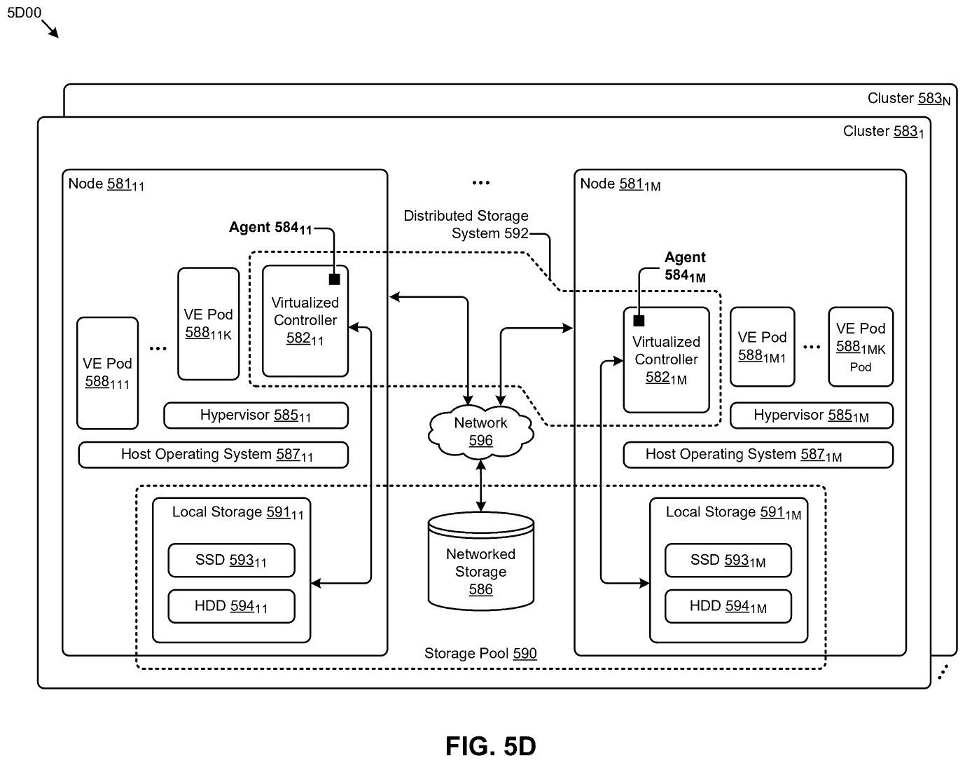

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 5A, FIG. 5B, FIG. 5C, and FIG. 5D.

FIG. 5A depicts a virtualized controller as implemented in the shown virtual machine architecture 5A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container in an executable container system, or within a layer (e.g., such as hypervisor layer 507). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 5A00 comprises a collection of interconnected components suitable for implementing embodiments of the present disclosure and/or for use in the herein-described environments. Moreover, virtual machine architecture 5A00 includes a controller virtual machine instance 530 in configuration 5511 that is further described below as pertaining to implementation of such a controller virtual machine instance 530. Configuration 5511 supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 530.

In this and other configurations, a controller virtual machine instance receives block I/O storage requests as network file system (NFS) requests in the form of NFS requests 502, and/or internet small computer system interface (iSCSI) block IO requests in the form of iSCSI requests 503, and/or Samba file system (SMB) requests in the form of SMB requests 504. The controller virtual machine (CVM) instance publishes and responds to an internet protocol (IP) address (e.g., CVM IP address 510). Various forms of input and output can be handled by one or more IO control (IOCTL) handler functions (e.g., IOCTL handler functions 508) that interface to other functions such as data IO manager functions 514 and/or metadata manager functions 522. As shown, the data IO manager functions can include communication with virtual disk configuration manager 512 and/or can include direct or indirect communication with any of various block IO functions (e.g., NFS 532, iSCSI 533, SMB 534, etc.).

In addition to block IO functions, configuration 5511 supports input or output (IO) of any form (e.g., block IO, streaming IO) and/or packet-based IO such as hypertext transport protocol (HTTP) traffic, etc., through either or both of a user interface (UI) handler such as UI IO handler 540 and/or through any of a range of application programming interfaces (APIs), possibly through API IO manager 545.

Communications link 515 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 530 includes content cache manager facility 516 that accesses storage locations, possibly including local dynamic random access memory (DRAM) (e.g., through local memory device access block 518) and/or possibly including accesses to local solid state storage (e.g., through local SSD device access block 520).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 531, which in turn can be formatted into any one or more storage areas, and which can comprise parameterized storage accessible by a key (e.g., a filename, a table name, a block address, an offset address, etc.). Data repository 531 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 524. The data repository 531 can be configured using CVM virtual disk controller 526, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 551₁ can be coupled by communications link 515 (e.g., backplane, local area network, public switched telephone network, wired or wireless network, etc.) and each instance may perform respective portions of sequences of instructions as may be required to practice embodiments of the disclosure.

The shown computing platform 506 is interconnected to the Internet 548 through one or more network interface ports (e.g., network interface port 5231 and network interface port 5232). Configuration 551₁ can be addressed through one or more network interface ports using an IP address. Any operational element within computing platform 506 can perform sending and receiving operations using any of a range of network protocols, possibly including network protocols that send and receive packets (e.g., network protocol packet 5211 and network protocol packet 5212).

Computing platform 506 may transmit and receive messages that can be composed of configuration data and/or any other forms of data and/or instructions organized into a data structure (e.g., communications packets). In some cases, the data structure includes program instructions (e.g., application code) communicated through the Internet 548 and/or through any one or more instances of communications link 515. Received program instructions may be processed and/or executed by a CPU as it is received and/or program instructions may be stored in any volatile or non-volatile storage for later execution. Program instructions can be transmitted via an upload (e.g., an upload from an access device over the Internet 548 to computing platform 506). Further, program instructions and/or the results of executing program instructions can be delivered to a particular user via a download (e.g., a download from computing platform 506 over the Internet 548 to an access device).

Configuration 551₁ is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to in-place coordination of a cluster-wide upgrade of a virtualization system OS without requiring a temporary upgrade node. In some embodiments, a module may include one or more state machines and/or combinational logic used to implement or facilitate the operational and/or performance characteristics pertaining to in-place coordination of a cluster-wide upgrade of a virtualization system OS without requiring a temporary upgrade node.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of in-place coordination of a cluster-wide upgrade of a virtualization system OS without requiring a temporary upgrade node). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to in-place coordination of a cluster-wide upgrade of a virtualization system OS without requiring a temporary upgrade node, and/or for improving the way data is manipulated when performing computerized operations pertaining to coordinating a node upgrade sequence using shutdown tokens.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 5B depicts a virtualized controller implemented by containerized architecture 5B00. The containerized architecture comprises a collection of interconnected components suitable for implementing embodiments of the present disclosure and/or for use in the herein-described environments. Moreover, the shown containerized architecture 5B00 includes an executable container instance 550 in configuration 5512 that is further described below as pertaining to executable container instance 550. Configuration 5512 includes an operating system layer (the shown OS pod 535) that performs addressing functions such as providing access to external requestors (e.g., user virtual machines or other processes) via an IP address 559 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS pod 535) can perform port forwarding to any executable container (e.g., executable container instance 550). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is”, “dir”, etc.). The executable container might optionally include various container runtime components 578, however such a separate set of container runtime components need not be necessarily provided. As an alternative, an executable container can include runnable instance 558, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 576. Such a container virtual disk controller can perform any of the functions that the aforementioned CVM virtual disk controller 526 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 517 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 5C depicts a virtualized controller implemented by a daemon-assisted containerized architecture 5C00. The containerized architecture comprises a collection of interconnected components suitable for implementing embodiments of the present disclosure and/or for use in the herein-described environments. Moreover, the shown daemon-assisted containerized architecture includes a user executable container instance 570 in configuration 5513 that is further described below as pertaining to user executable container instance 570. Configuration 5513 includes a daemon layer 537 that performs certain functions of an operating system.

User executable container instance 570 comprises any number of user containerized functions (e.g., user containerized function1 560₁, user containerized function2 560₂, . . . , user containerized functionN 560₃). Such user containerized functions can execute autonomously or can be interfaced with or wrapped in a runnable object to create a runnable instance (e.g., runnable instance 558). In some cases, the shown container runtime components 578 comprise portions of an operating system, which portions are interfaced with or included in the runnable instance and/or any user containerized functions. In this embodiment of a daemon-assisted containerized architecture, the computing platform 506 might or might not host any of the container runtime components 578.

The virtual machine architecture 5A00 of FIG. 5A and/or the containerized architecture 5B00 of FIG. 5B and/or the daemon-assisted containerized architecture 5C00 of FIG. 5C can be used in any combination to implement a distributed platform that contains multiple servers and/or nodes that manage multiple tiers of storage where the tiers of storage might be formed using the shown data repository 531 and/or any forms of network accessible storage. As such, the multiple tiers of storage may include storage that is accessible over communications link 515. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manages the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 5D depicts a distributed virtualization system in a multi-cluster environment 5D00. The shown distributed virtualization system is configured to be used to implement the herein disclosed techniques. Specifically, the distributed virtualization system of FIG. 5D comprises multiple clusters (e.g., cluster 583₁, . . . , cluster 583_{N}) comprising multiple nodes that have multiple tiers of storage in a storage pool. Representative nodes (e.g., node 581₁₁, . . . , node 581_{1M}) and storage pool 590 associated with cluster 583₁ are shown. Each node can be associated with one server, multiple servers, or portions of a server. The nodes can be associated (e.g., logically and/or physically) with the clusters. As shown, the multiple tiers of storage include storage that is accessible through a network 596, such as a networked storage 586 (e.g., a storage area network or SAN, network attached storage or NAS, etc.). The multiple tiers of storage further include instances of local storage (e.g., local storage 591₁₁, . . . , local storage 591_{1M}). For example, the local storage can be within or directly attached to a server and/or appliance associated with the nodes. Such local storage can include solid state drives (SSD 593₁₁, . . . , SSD 593_{1M}), hard disk drives (HDD 594₁₁, . . . , HDD 594_{1M}), and/or other storage devices.

As shown, any of the nodes of the distributed virtualization system can implement one or more user virtualized entities (VEs) such as the virtualized entity pods (VE pods) shown as VE pod 588₁₁₁, . . . , VE pod 588_{11K}, . . . , VE pod 588_{1M1}, . . . , VE pod 588_{1MK}, and/or a distributed virtualization system can implement one or more virtualized entities that may be embodied as a virtual machines (VM) and/or as any form of executable pod or executable container. The VEs can be characterized as software-based computing “machines” implemented in a container-based or hypervisor-assisted virtualization environment that emulates a virtualization system's operating system and/or its underlying hardware resources (e.g., CPU, memory, etc.) of the nodes. For example, multiple VE pods can operate on one physical machine (e.g., node host computer) running a single host operating system (e.g., host operating system 587₁₁, . . . , host operating system 587_{1M}), while the VE pods run multiple services, with or without participation by a respective guest operating system. Such flexibility can be facilitated at least in part by a hypervisor (e.g., hypervisor instance 585₁₁, . . . , hypervisor instance 585_{1M}), which hypervisor instances are logically located between the various guest operating systems and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 587₁₁, . . . , host operating system 587_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 590 by the VMs and/or the executable containers.

Multiple instances of such virtualized controllers can coordinate within a cluster to form the distributed storage system 592 which can, among other operations, manage the storage pool 590. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 581₁₁ can interface with a controller virtual machine (e.g., virtualized controller 58211) through hypervisor instance 585₁₁ to access data of storage pool 590. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 592. For example, a hypervisor at one node in the distributed storage system 592 might correspond to software from a first vendor, and a hypervisor at another node in the distributed storage system 592 might correspond to a second software vendor. As another virtualized controller implementation example, executable containers can be used to implement a virtualized controller (e.g., virtualized controller 582_{1M}) in an operating system virtualization environment at a given node. In this case, for example, the virtualized entities at node 581_{IM} can access the storage pool 590 by interfacing with a controller container (e.g., virtualized controller 582_{1M}) through hypervisor instance 585_{1M} and/or the kernel of host operating system 587_{1M}.

In certain embodiments, one or more instances of an agent can be implemented in the distributed storage system 592 to facilitate the herein disclosed techniques. Specifically, agent 584₁₁ can be implemented in the virtualized controller 582₁₁, and agent 584_{1M} can be implemented in the virtualized controller 582_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to coordinating a node upgrade sequence using shutdown tokens can be brought to bear through implementation of any one or more of the foregoing techniques. Moreover, any aspect or aspects of how to carry out a zero downtime cluster upgrade without requiring allocation of any additional nodes can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for in-place coordination of an upgrade to a cluster of a containerized system without requiring a temporary upgrade node, the acts comprising:
selecting a first node from the cluster of the containerized system;
enabling a protocol whereby operational elements of the cluster observe an upgrade token passing algorithm to ensure mutual exclusivity of a sequence of operations as between individual nodes of the cluster; and
upgrading the cluster by applying code updates one node at a time.

2. The non-transitory computer readable medium of claim 1, wherein the first node signals, to an intent processor, an intent to upgrade.

3. The non-transitory computer readable medium of claim 1, wherein all or part of the cluster is a Kubernetes cluster.

4. The non-transitory computer readable medium of claim 1, wherein all or part of the cluster implements a hyperconverged infrastructure (HCI) cluster.

5. The non-transitory computer readable medium of claim 1, wherein, responsive to the selecting of a first node from the cluster of the containerized system, further acts include performing a series of pre-checks before executing upgrade code or applying upgrade parameters.

6. The non-transitory computer readable medium of claim 5, wherein at least some of the series of pre-checks comprise determining if another cluster is currently undergoing an upgrade.

7. The non-transitory computer readable medium of claim 1, wherein at least some of the code updates are implemented using an operator of a custom resource definition (CRD).

8. The non-transitory computer readable medium of claim 1, wherein the cluster is a Kubernetes cluster wherein rolling code updates are applied to the Kubernetes cluster by replacing at least some instances of Kubernetes pods with upgraded Kubernetes pods.

9. A method for in-place coordination of an upgrade to a cluster of a containerized system without requiring a temporary upgrade node, the method comprising:
selecting a first node from the cluster of the containerized system;
enabling a protocol whereby operational elements of the cluster observe an upgrade token passing algorithm to ensure mutual exclusivity of a sequence of operations as between individual nodes of the cluster; and
upgrading the cluster by applying code updates one node at a time.

10. The method of claim 9, wherein the first node signals, to an intent processor, an intent to upgrade.

11. The method of claim 9, wherein all or part of the cluster is a Kubernetes cluster.

12. The method of claim 9, wherein all or part of the cluster implements a hyperconverged infrastructure (HCI) cluster.

13. The method of claim 9, wherein, responsive to the selecting of the first node from the cluster of the containerized system, the method further comprises performing a series of pre-checks before executing upgrade code or applying upgrade parameters.

14. The method of claim 13, wherein at least some of the series of pre-checks comprise determining if another cluster is currently undergoing an upgrade.

15. The method of claim 9, wherein at least some of the code updates are implemented using an operator of a custom resource definition (CRD).

16. The method of claim 9, wherein the cluster is a Kubernetes cluster wherein rolling code updates are applied to the Kubernetes cluster by replacing at least some instances of Kubernetes pods with upgraded Kubernetes pods.

17. A system for in-place coordination of an upgrade to a cluster of a containerized system without requiring a temporary upgrade node, the system comprising:
a storage medium having stored thereon a sequence of instructions; and
a processor that executes the sequence of instructions to cause the processor to perform acts comprising,
selecting a first node from the cluster of the containerized system;
enabling a protocol whereby operational elements of the cluster observe an upgrade token passing algorithm to ensure mutual exclusivity of a sequence of operations as between individual nodes of the cluster; and
upgrading the cluster by applying code updates one node at a time.

18. The system of claim 17, wherein the first node signals, to an intent processor, an intent to upgrade.

19. The system of claim 17, wherein all or part of the cluster is a Kubernetes cluster.

20. The system of claim 17, wherein all or part of the cluster implements a hyperconverged infrastructure (HCI) cluster.
